(19) United States
(12) Patent Application Publication
(10) Pub. No.: US 2019/0123538 A1
(43) Pub. Date: Apr. 25, 2019

(54) Switch Box

(71) Applicant: Shih-Lin Chang, Tainan City (TW)

(72) Inventor: Shih-Lin Chang, Tainan City (TW)

(21) Appl. No.: 15/790,150

(22) Filed: Oct. 23, 2017

(51) Int. Cl. H02G 3/14

(52) U.S. Cl. CPC H02G 3/14

(57) ABSTRACT

A switch box contains: a collapsible body including a flat accommodation plate and multiple fold parts. The flat accommodation plate includes a holding fence, a first peripheral fence, a second peripheral fence, a third peripheral fence, a fourth peripheral fence, two first fixing blocks, and two second fixing blocks. Each of the two first fixing blocks has a first through orifice defined thereon, and each of the two second fixing blocks has a second through orifice formed thereon. The first peripheral fence has two first operation protrusions, and the second peripheral fence has two second operation protrusions so that that the flat accommodation plate is foldable along the multiple fold parts. The switch box contains further contains a lid detachably connected with the collapsible body.

### BACKGROUND OF THE INVENTION

### Field of the Invention

The present invention relates to a switch box, and more particularly to the switch box which is made of nonmetal material.

### Description of the Prior Art

A switch box is called as distribution box, total switch box, power box, and telecommunication box which are used to accommodate a switch, a breaker, a measuring instrument, an electric protector, and other auxiliary equipment.

However, the conventional switch box contains a body and a lid which are made of metal material. Thus increasing fabrication cost. When the switch box is the telecommunication box, telecommunications signals (such as wireless signals) are interfered by the telecommunication box seriously.

An improved switch box made of nonmetal material (such as plastic material or fiber-reinforced plastic (FRP)) is developed so as to overcome above-mentioned problems. Nevertheless, this improved switch box is injection molded by way of a mold, so a body or a lid of the improved switch box is three-dimensional, for example, the body is hollow and is in a square or rectangle shape, and the lid is in an L or C shape, thus increasing storage space and shipment cost.

The present invention has arisen to mitigate and/or obviate the afore-described disadvantages.

### SUMMARY OF THE INVENTION

The primary objective of the present invention is to provide a switch box which is portable easily by user or by using vehicles.

Another objective of the present invention is to provide a switch box which is storable in a small size.

To achieve above-mentioned objectives, a switch box provided by the present invention contains: a collapsible body including a flat accommodation plate one-piece formed from plastic material, and the collapsible body including multiple fold parts arranged on the accommodation plate.

The flat accommodation plate includes a holding fence, a first peripheral fence connecting with a first side of the holding fence, a second peripheral fence connecting with a second side of the holding fence opposite to the first side of the holding fence, a third peripheral fence coupling with a third side of the holding fence between the first and second sides of the holding fence, a fourth peripheral fence coupling with a fourth side of the holding fence opposite to the third side of the holding fence, two first fixing blocks mounted on two ends of the third peripheral fence respectively, and two second fixing blocks fixed on two ends of the fourth peripheral fence individually; each of the two first fixing blocks has a first through orifice defined thereon, and each of the two second fixing blocks has a second through orifice formed thereon; the first peripheral fence has two first operation protrusions, and the second peripheral fence has two second operation protrusions so that that the flat accommodation plate is foldable along the multiple fold parts.

The switch box further contains a lid detachably connected with the collapsible body.

### BRIEF DESCRIPTION OF THE DRAWINGS

FIG. 1 is a perspective view showing the exploded components of a switch box in accordance with a preferred embodiment of the present invention.

FIG. 2 is a side plan view showing the assembly of the switch box in accordance with the preferred embodiment of the present invention.

FIG. 3 is a perspective view showing the assembly of a part of the switch box in accordance with the preferred embodiment of the present invention.

FIG. 4 is a perspective view showing the operation of the switch box in accordance with the preferred embodiment of the present invention.

FIG. 5 is a perspective view showing the application of the switch box in accordance with the preferred embodiment of the present invention.

FIG. 6 is another perspective view showing the application of the switch box in accordance with the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

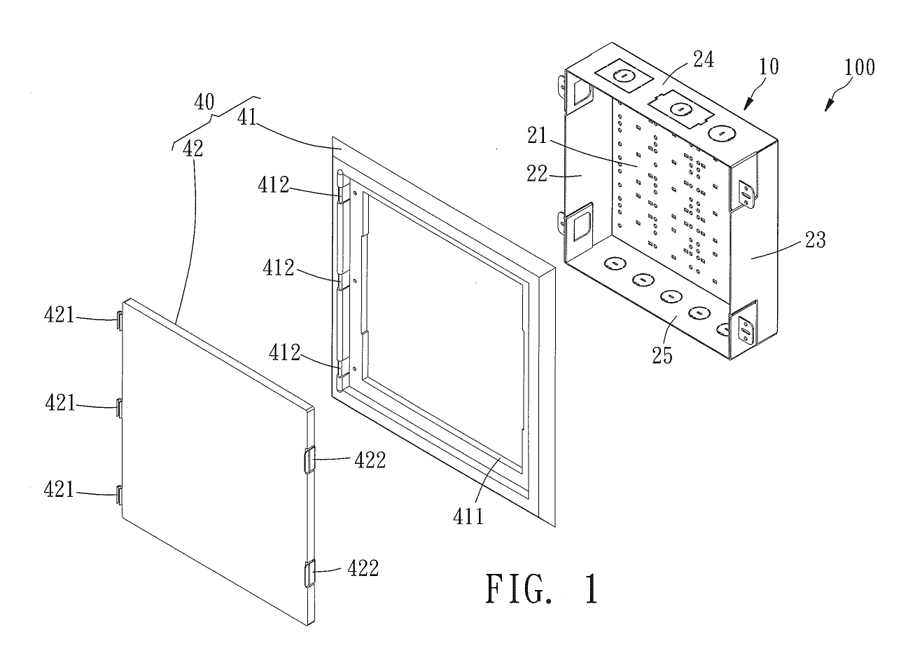

With reference to FIGS. 1-6, a switch box 100 in accordance with a preferred embodiment of the present invention comprises: a collapsible body 10 and a lid 40.

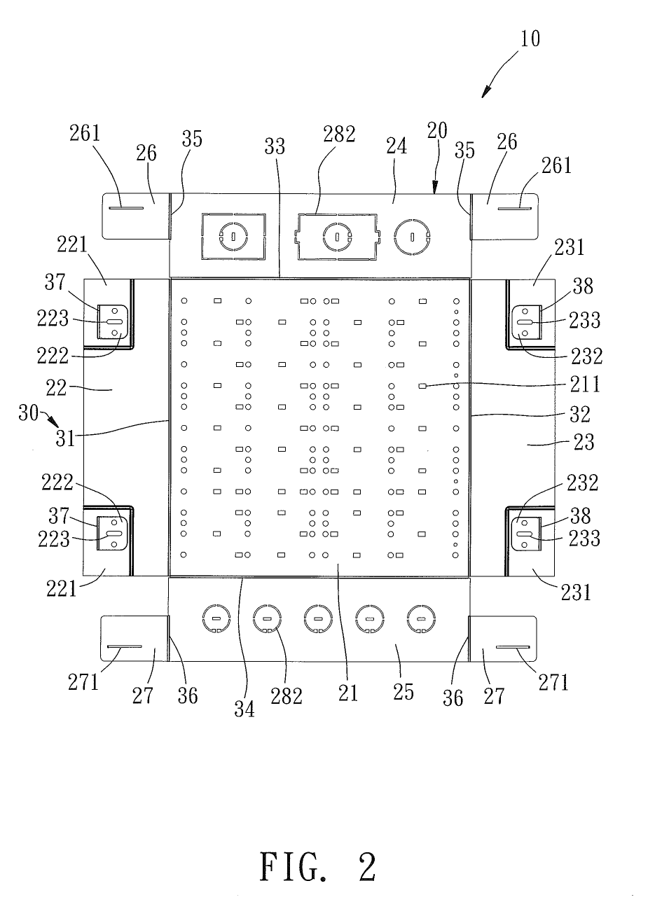

Referring to FIG. 2, the collapsible body 10 includes a flat accommodation plate 20 one-piece formed from plastic material, and the collapsible body 10 includes multiple fold parts 30 arranged on the accommodation plate 20, wherein the multiple parts 30 separate a holding fence 21, a first peripheral fence 22 connecting with a first side of the holding fence 21, a second peripheral fence 23 connecting with a second side of the holding fence 21 opposite to the first side of the holding fence 21, a third peripheral fence 24 coupling with a third side of the holding fence 21 between the first and second sides of the holding fence 21, a fourth peripheral fence 25 coupling with a fourth side of the holding fence 21 opposite to the third side of the holding fence 21, two first fixing blocks 26 mounted on two ends of the third peripheral fence 24 respectively, and two second fixing blocks 27 fixed on two ends of the fourth peripheral fence 25 individually. Each of the two first fixing blocks 26 has a first through orifice 261 defined thereon, and each of the two second fixing blocks 27 has a second through orifice 271 formed thereon.

The first peripheral fence 22 has two first recessed areas 221, each of which has a first operation protrusion 222 arranged on each first recessed area 221, wherein the second peripheral fence 23 has two second recessed areas 231, each of which has a second operation protrusion arranged on each second recessed area 231.

The multiple fold parts 30 are a first foldable marking 31 formed between the holding fence 21 and the first peripheral fence 22, a second foldable marking 32 formed between the holding fence 21 and the second peripheral fence 23, a third foldable marking 33 formed between the holding fence 21 and the third peripheral fence 24, a fourth foldable marking 34 formed between the holding fence 21 and the fourth peripheral fence 25, two fifth foldable markings 35 respectively defined among the third peripheral fence 24 and the two first fixing blocks 26, two sixth foldable markings 36 respectively defined among the fourth peripheral fence 25 and the second fixing block 27, two seventh foldable markings 37 respectively defined among and two first operation protrusions 222 of the two first recessed areas 221 of the first peripheral fence 22, and two eighth foldable markings 38 respectively defined among and two second operation protrusions 232 of the two second recessed areas 231 of the second peripheral fence 23.

As shown in FIG. 1, the lid 40 includes a support frame 41 and an affix plate 42, wherein the support frame 41 is made of plastic material, and the affix plate 42 is made of plastic material. The support frame 41 has a chamber 411 defined on a central position thereof, and the chamber 411 has multiple connection elements 412 arranged on one side thereof. The affix plate 42 has multiple connection portions 421 mounted on a first side thereof, wherein each of the multiple connection portions 421 has a C-shape cross section, and the affix plate 42 also has multiple flexible retainers 422 mounted on a second end thereof.

In the assembly, the collapsible body 10 is folded, for example:

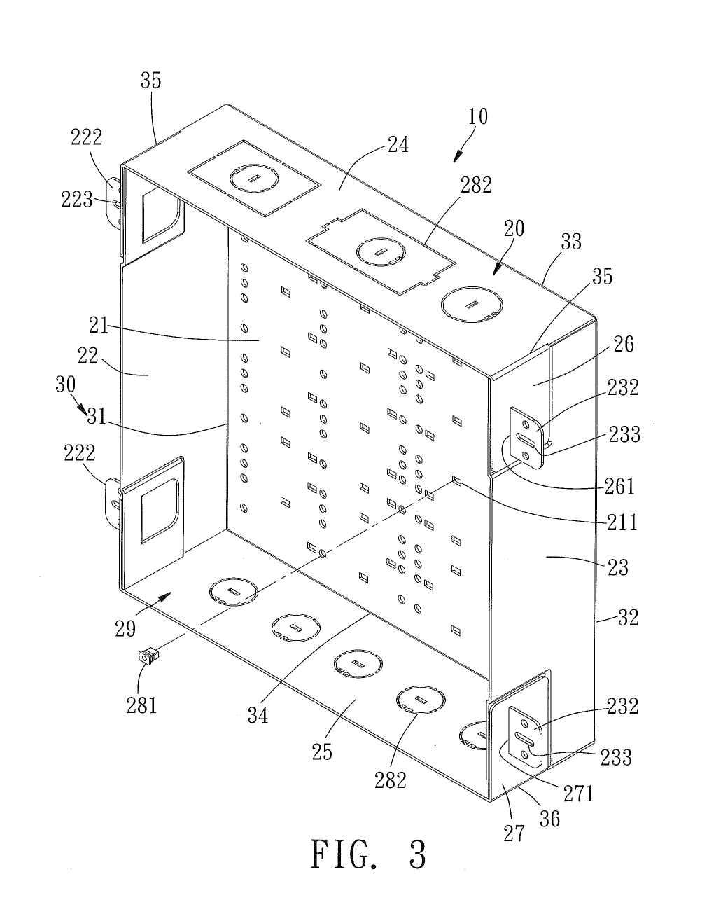

as shown in FIGS. 2 and 3, the first peripheral fence 22 is forward folded 90 degrees along the first foldable marking 31, and the two first operation protrusions 222 are folded 90 degrees outward along the two seventh foldable markings 37, the second peripheral fence 23 is forward folded 90 degrees along the second foldable marking 32, and the two second operation protrusions 232 are folded 90 degrees outward along the two eighth foldable markings 38, the third peripheral fence 24 is forward folded 90 degrees along the third foldable marking 33, and the two first fixing blocks 26 are folded 90 degrees downward along the two fifth foldable markings 35 so that one of the two first operation protrusions 222 and one of the two second operation protrusions 232 extend out of two first through holes 261 of the two first fixing blocks 26 respectively. Thereafter, the fourth peripheral fence 25 is forward folded 90 degrees along the fourth foldable marking 34, and the two second fixing blocks 27 are folded 90 degrees upward along the two sixth foldable markings 36 individually so that the other first operation protrusion 222 and the other second operation protrusion 232 extend out of two second through orifice 271 of the two second fixing blocks 27 respectively, thus forming the flat accommodation plate 20. Furthermore, the holding fence 21, the first peripheral fence 22, the second peripheral fence 23, the third peripheral fence 24, and the fourth peripheral fence 25 define a receiving room 29, as illustrated in FIGS. 1 and 3.

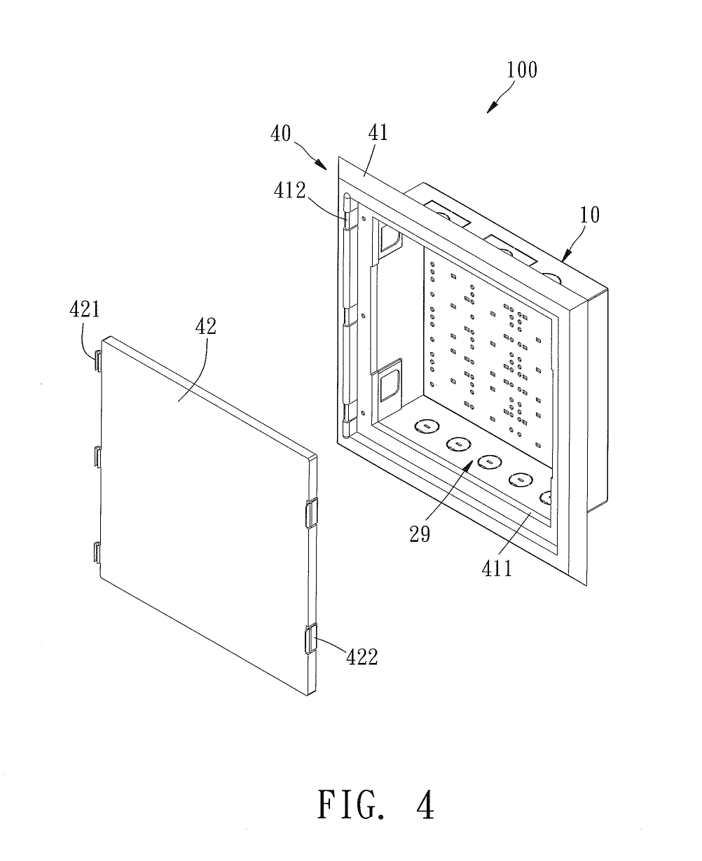

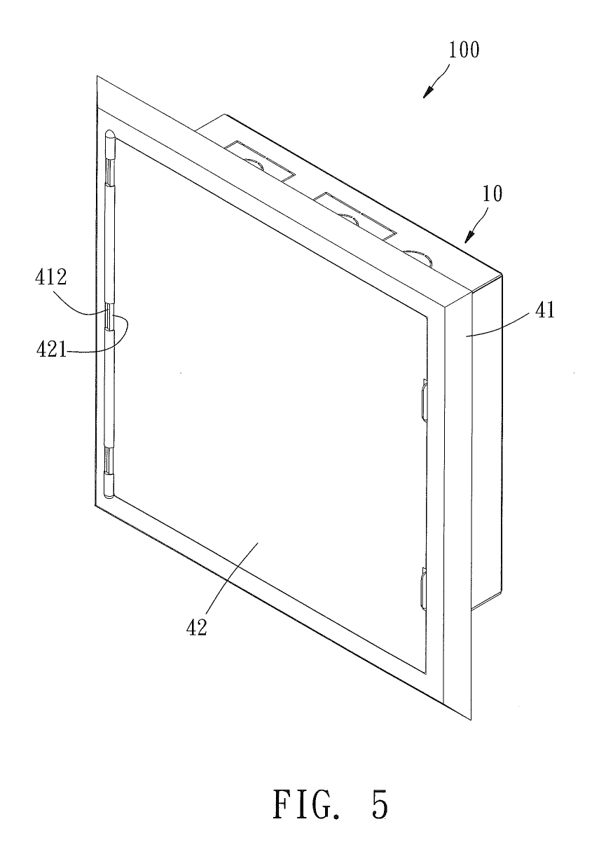

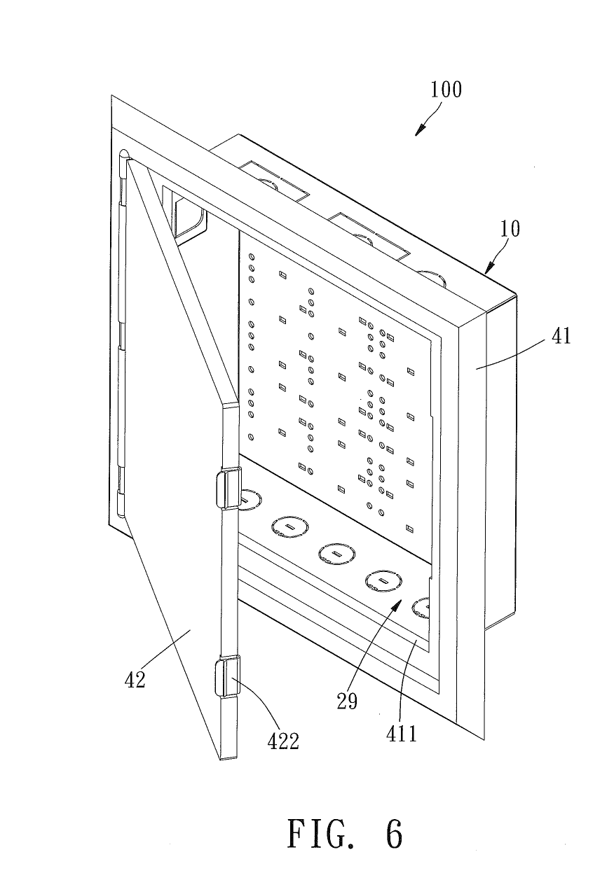

Referring further to FIG. 4, the support frame 41 of the lid 40 engages with the collapsible body 10 so that the chamber 411 communicates with the receiving room 29. Thereafter, the multiple connection portions 421 of the affix plate 42 of the lid 40 rotatably connect with the multiple connection elements 412 of the support frame 41, hence when the multiple flexible retainers 422 engage with the support frame 41, the affix plate 42 closes the receiving room 29, as shown in FIG. 5. When the multiple flexible retainers 422 remove from the support frame 41, the affix plate 42 opens the receiving room 29, as illustrated in FIG. 6.

Before folding the collapsible body 10 (i.e., the switch box is not mounted in a build), it is a panel so that the switch box is portable easily by user or by using vehicles. Preferably, the switch box is storable in a small size.

Each of the two first operation protrusions 222 has at least one first aperture 223, and each of the two second operation protrusions 232 of the collapsible body 10 has at least one second aperture 233 so as to accommodate each of a plurality of screws, thus fixing the collapsible body 10 in the building.

The holding fence 21 of the collapsible body 10 further has multiple openings 211 defined thereon so as to connecting with locking elements 281 of a power switch (or a telecommunication switch), as shown in FIG. 3, hence the power switch is accommodated in the receiving room 29 of the collapsible body 10.

Each of the third peripheral fence 24 and the fourth peripheral fence 25 of the collapsible body 10 has multiple positioning blocks 282 connected thereon, wherein the multiple positioning blocks 282 are removed from the third peripheral fence 24 and the fourth peripheral fence 25 easily by an external force so as to fix piping systems, pipelines, electric wires, and signal wires.

While various embodiments in accordance with the present invention have been shown and described, it is clear to those skilled in the art that further embodiments may be made without departing from the scope of the present invention.

What is claimed is:

1. A switch box comprising:
a collapsible body including a flat accommodation plate one-piece formed from plastic material, and the collapsible body including multiple fold parts arranged on the accommodation plate;
wherein the flat accommodation plate includes a holding fence, a first peripheral fence connecting with a first side of the holding fence, a second peripheral fence connecting with a second side of the holding fence opposite to the first side of the holding fence, a third peripheral fence coupling with a third side of the holding fence between the first and second sides of the holding fence, a fourth peripheral fence coupling with a fourth side of the holding fence opposite to the third side of the holding fence, two first fixing blocks mounted on two ends of the third peripheral fence respectively, and two second fixing blocks fixed on two ends of the fourth peripheral fence individually; each of the two first fixing blocks has a first through orifice defined thereon, and each of the two second fixing blocks has a second through orifice formed thereon; the first peripheral fence has two first operation protrusions, and the second peripheral fence has two second operation protrusions so that that the flat accommodation plate is foldable along the multiple fold parts;
a lid detachably connected with the collapsible body.

2. The switch box as claimed in claim 1, wherein the first peripheral fence has two first recessed areas, each of which has the first operation protrusion arranged on each first recessed area; and the second peripheral fence has two second recessed areas, each of which has a second operation protrusion arranged on each second recessed area.

3. The switch box as claimed in claim 1, wherein the multiple fold parts are a first foldable marking formed between the holding fence and the first peripheral fence, a second foldable marking formed between the holding fence and the second peripheral fence, a third foldable marking formed between the holding fence and the third peripheral fence, a fourth foldable marking formed between the holding fence and the fourth peripheral fence, two fifth foldable markings respectively defined among the third peripheral fence and the two first fixing blocks, two sixth foldable markings respectively defined among the fourth peripheral fence and the second fixing block, two seventh foldable markings respectively defined among and two first operation protrusions of the two first recessed areas of the first peripheral fence, and two eighth foldable markings respectively defined among and two second operation protrusions of the two second recessed areas of the second peripheral fence.

4. The switch box as claimed in claim 3, wherein the collapsible body is folded, the first peripheral fence is forward folded along the first foldable marking, and the two first operation protrusions are folded outward along the two seventh foldable markings, the second peripheral fence is forward folded along the second foldable marking, and the two second operation protrusions are folded outward along the two eighth foldable markings, the third peripheral fence is forward folded along the third foldable marking, and the two first fixing blocks are folded downward along the two fifth foldable markings so that one of the two first operation protrusions and one of the two second operation protrusions extend out of two first through holes of the two first fixing blocks respectively, wherein the fourth peripheral fence is forward folded along the fourth foldable marking, and the two second fixing blocks are folded upward along the two sixth foldable markings individually so that the other first operation protrusion and the other second operation protrusion extend out of two second through orifice of the two second fixing blocks respectively, thus forming the flat accommodation plate; wherein the holding fence, the first peripheral fence, the second peripheral fence, the third peripheral fence, and the fourth peripheral fence define a receiving room.

5. The switch box as claimed in claim 1, wherein the lid includes a support frame and an affix plate, the support frame is made of plastic material, and the affix plate is made of plastic material; the support frame has a chamber defined on a central position thereof, and the chamber has at least one connection element arranged on one side thereof, the affix plate has at least one connection portion mounted on a first side thereof, and the affix plate also at least one multiple flexible retainer mounted on a second end thereof; wherein the support frame of the lid engages with the collapsible body so that the chamber communicates with a receiving room, and the at least one connection portion of the affix plate of the lid rotatably connects with the at least one connection element of the support frame, hence when the at least one flexible retainer engages with the support frame, the affix plate closes the receiving room, and when the at least one flexible retainer removes from the support frame, the affix plate opens the receiving room.

6. The switch box as claimed in claim 1, wherein each of the two first operation protrusions has at least one first aperture, and each of the two second operation protrusions of the collapsible body has at least one second aperture.

7. The switch box as claimed in claim 1, wherein the holding fence of the collapsible body further has multiple openings defined thereon.

8. The switch box as claimed in claim 1, wherein each of the third peripheral fence and the fourth peripheral fence of the collapsible body has multiple positioning blocks connected thereon, and the multiple positioning blocks are removed from the third peripheral fence and the fourth peripheral fence easily by an external force.
